(19) United States
(12) Patent Application Publication
(10) Pub. No.: US 2011/0017490 A1
(43) Pub. Date: Jan. 27, 2011

(54) Cable for use in a condensing photovoltaic apparatus

(75) Inventors: Hwa-yuh Shin, Longtan Shiang (TW); Hung-zen Kuo, Longtan Shiang (TW); Kuo-hsin Lin, Longtan Shiang (TW); Hwen-fen Hong, Longtan Shiang (TW)

Correspondence Address: Jackson Intellectual Property Group PLLC, 106 Starvale Lane, Shipman, VA, 22971, US

(73) Assignee: ATOMIC ENERGY COUNCIL-INSTITUTE OF NUCLEAR ENERGY RESEARCH, Taoyuan (TW)

(21) Appl. No.: 12/149,529

(22) Filed: May 2, 2008

(51) Int. Cl. H01B 9/02; H01B 3/30; H01B 7/00

(52) U.S. Cl. 174/103; 174/110 SR; 174/113 R; 174/102 R

(57) ABSTRACT

There is disclosed a cable for use in a condensing photovoltaic apparatus. The cable includes a core and sheath. The core is made of a conductive material. The sheath is provided around the core and made of white Teflon. Therefore, the sheath absorbs less heat than a sheath made of other colors would. Moreover, the sheath stands high temperatures since it is made Teflon.

### FIELD OF THE INVENTION

The present invention relates to a condensing photovoltaic apparatus and, more particularly, to a cable for a condensing photovoltaic apparatus.

### DESCRIPTION OF THE RELATED ARTS

A condensing photovoltaic apparatus includes a plurality of solar-cell modules and cables for connecting the solar-cell modules to one another. The cables may be ordinary cables or coaxial cables. The performance of the condensing photovoltaic apparatus is related to the quality of the cables. An ordinary cable includes a conductive strand and an isolating sheath around the strand. A coaxial cable includes a conductive strand, an isolating tube around the strand, a conductive web around the isolating tube, and an isolating sheath around the web. The quality of the cables is related to the quality of the sheath.

In operation, the photovoltaic apparatus is exposed to the sunlight to convert the sunlight to electricity. The cables are inevitably exposed to the sunlight. Generally, the sheaths are made of many colors but white. Therefore, the sheaths absorb more heat than a white sheath would, such that the sheaths inevitably get hot. Unfortunately, the sheaths are often made of materials that do not stand high temperature, so that the sheaths are probably molten. In that case, the strands or webs of the cables contact one another or other metal parts of the photovoltaic apparatus, thus causing short circuit. Therefore, the operation of the photovoltaic apparatus is jeopardized.

There has not been any study on the impact of the color and material of the sheaths on the quality of the sheaths. Therefore, the present invention is intended to obviate or at least alleviate the problems encountered in prior art.

### SUMMARY OF THE INVENTION

It is the primary objective of the present invention to provide a cable that absorbs little solar energy and stands high temperatures.

According to the present invention, the cable includes a core and sheath. The core is made of a conductive material. The sheath is provided around the core and made of white Teflon.

Other objectives, advantages and features of the present invention will become apparent from the following description referring to the attached drawings.

### BRIEF DESCRIPTIONS OF THE DRAWINGS

The present invention will be described via the detailed illustration of six embodiments referring to the drawings.

FIG. 1 is a cross-sectional view of a single-core cable according to the first embodiment of the present invention

FIG. 2 is a cross-sectional view of a duo-core cable according to the second embodiment of the present invention.

FIG. 3 is a cross-sectional view of a single-core cable according to the third embodiment of the present invention.

FIG. 4 is a cross-sectional view of a duo-core cable according to the forth embodiment of the present invention.

FIG. 5 is a cross-sectional view of a single-core coaxial cable according to the fifth embodiment of the present invention.

FIG. 6 is a cross-sectional view of a duo-core coaxial cable according to the sixth embodiment of the present invention.

FIG. 7 is a side view of a photovoltaic apparatus including at least two solar-cell modules connected to each other by at least one cable as shown in any of the foregoing drawings.

FIG. 8 is a top view of the photovoltaic apparatus shown in FIG. 7.

### DESCRIPTION OF THE PREFERRED EMBODIMENT

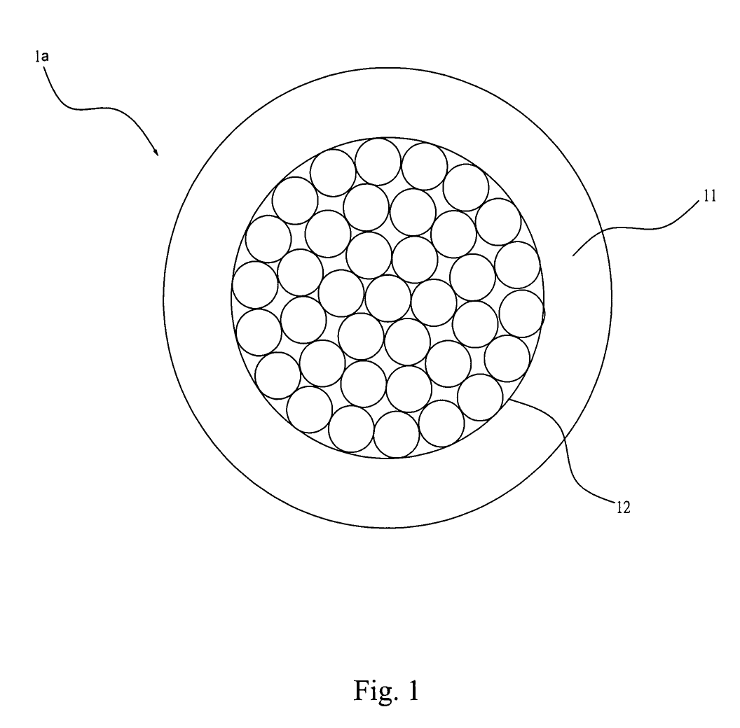

Referring to FIG. 1, there is shown a single-core cable 1a according to a first embodiment of the present invention. The single-core cable 1a includes a conductive core and an isolating sheath 11 around the core. The core includes at least one strand 12 and generally a plurality of strands 12. The sheath 11 is made of white Teflon.

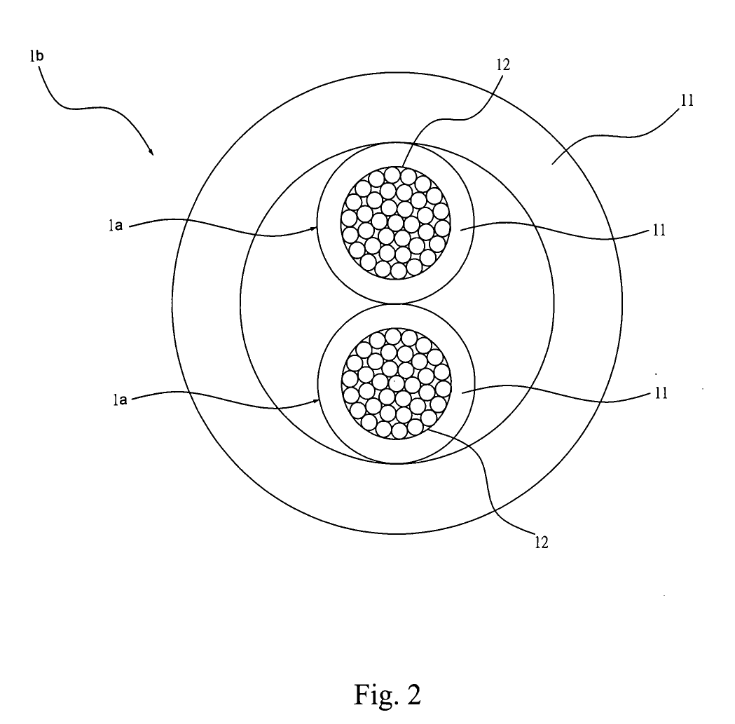

Referring to FIG. 2, there is shown a duo-core cable 1b according to a second embodiment of the present invention. The duo-core cable 1b includes two single-core cables 1a and an extra sheath 11 around the single-core cables 1a.

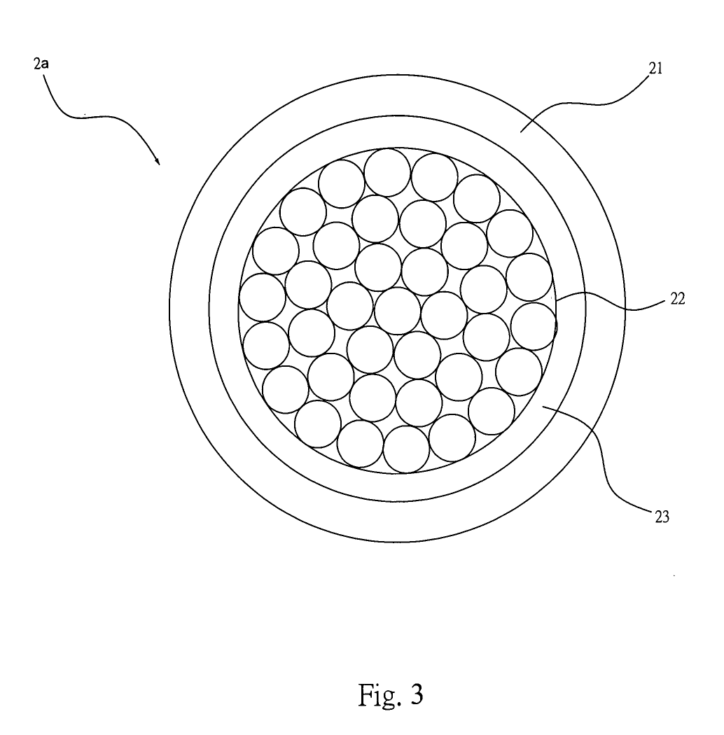

Referring to FIG. 3, there is a shown a single-core cable 2a according to a third embodiment of the present invention. The single-core cable 2a includes a conductive core, an insolating tube 23 around the core and an isolating sheath 21 around the tube 23. The core includes at least one strand 22 and generally a plurality of strands 22. The sheath 21 is made of white Teflon.

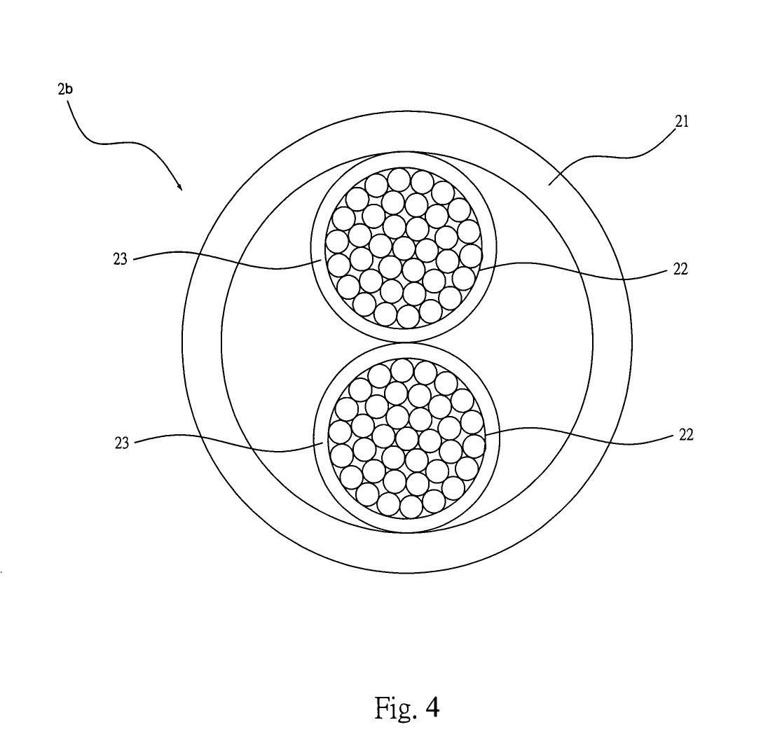

FIG. 4 is a cross-sectional view of a duo-core cable 2b according to a fourth embodiment of the present invention. The duo-core cable 2b includes two single-core cables 2a and an extra sheath 21 around the single-core cables 2a.

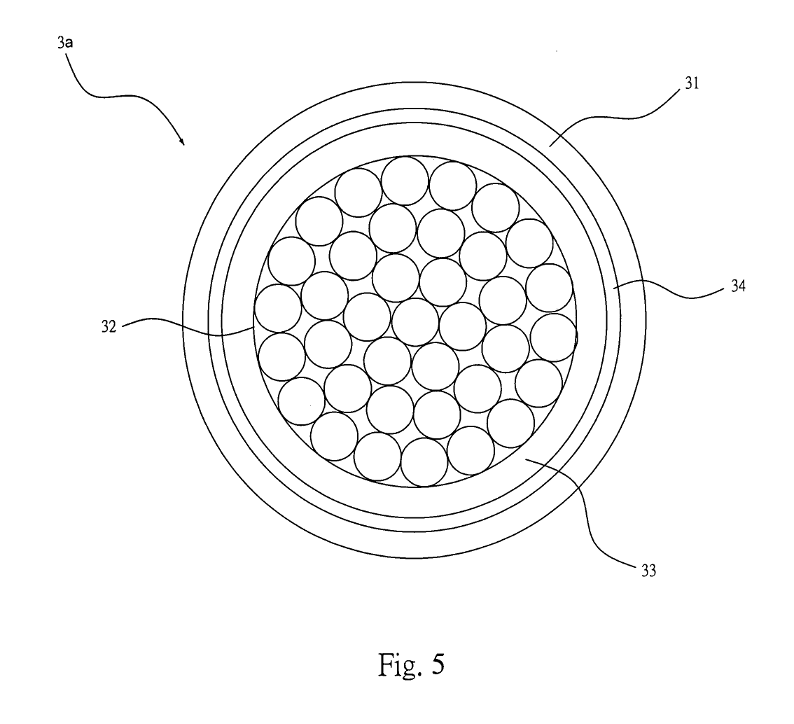

FIG. 5 is a cross-sectional view of a single-core coaxial cable 3a according to a fifth embodiment of the present invention. The single-core coaxial cable 3a includes a conductive core, an insolating tube 33 around the core, conductive web 34 around the tube 33 and an isolating sheath 31 around the web 34. The core includes at least one strand 32 and generally a plurality of strands 32. The sheath 31 is made of white Teflon.

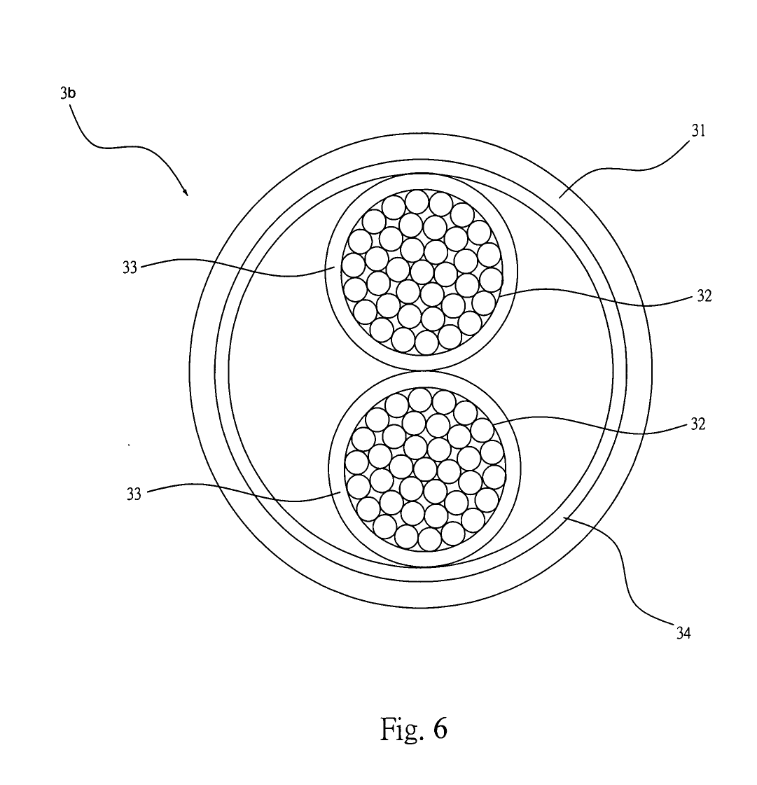

FIG. 6 is a cross-sectional view of a duo-core coaxial cable 3b according to a sixth embodiment of the present invention. The duo-core coaxial cable 3b includes two single-core coaxial cables 3a and an extra sheath 31 around the single-core coaxial cables 3a.

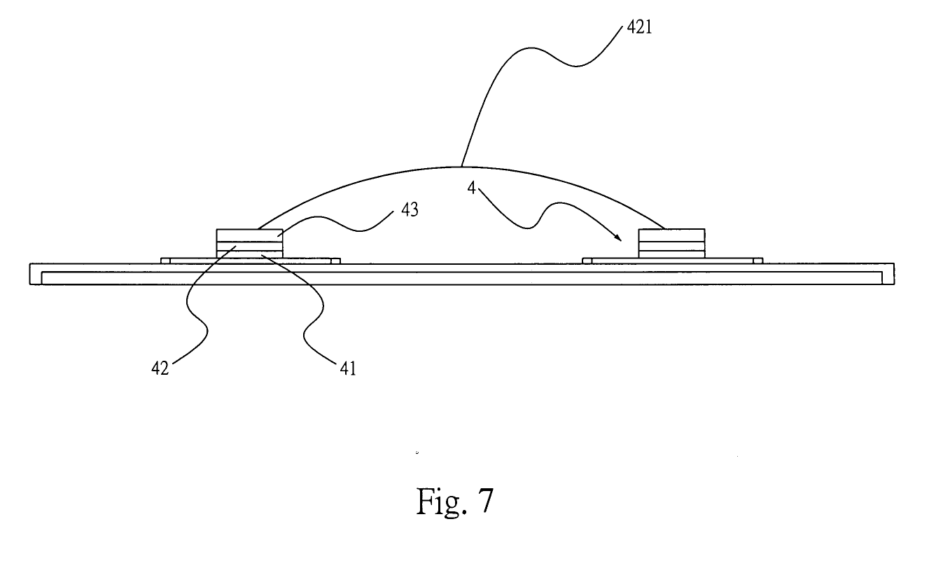

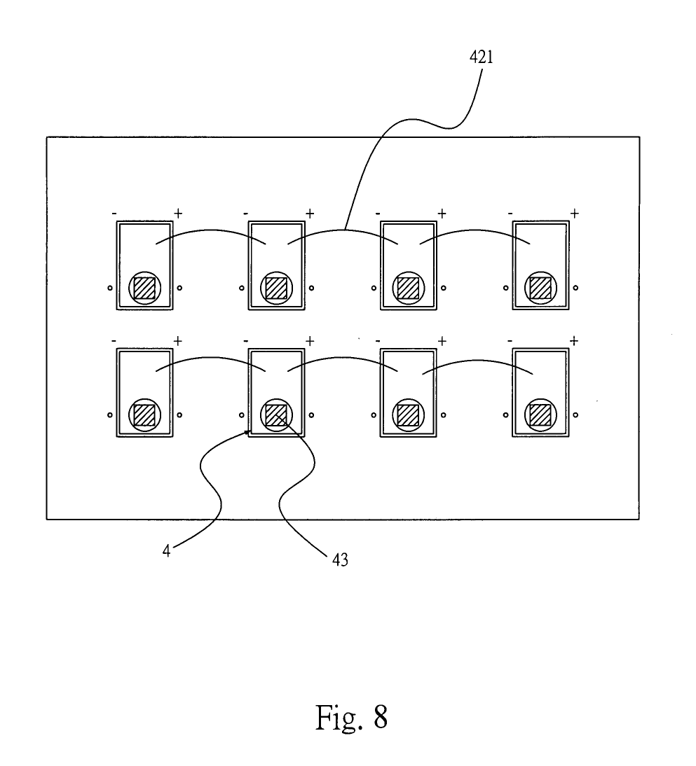

Referring to FIGS. 7 and 8, there is shown a photovoltaic apparatus including a plurality of solar-cell modules 4 connected to one another by a plurality of cables 421 according to any of the above-mentioned embodiments. Each of the solar-cell modules 4 includes a ceramic substrate 41, a conducting layer 42 on the ceramic substrate 41 and a solar cell 43 on the conducting layer 42.

As discussed above, the sheath is made of white Teflon. Therefore, the sheath absorbs less heat than a sheath of other colors would. Moreover, the sheath stands high temperature since it is made of Teflon.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A cable use in a condensing photovoltaic apparatus comprising:
a core made of a conductive material; and
a sheath provided around the core and made of white Teflon.

2. The cable according to claim 1, wherein the core comprises at least one strand.

3. A cable set comprising two cables according to claim 1 and an extra sheath provided around the cables and made of white Teflon.

4. The cable according to claim 1 comprising:
a tube provided around the core and made of an isolating material; and
a conductive web provided between the tube and the sheath and made of a conductive material

5. A cable set comprising two cables according to claim 4 and an extra sheath provided around the cables and made of white Teflon.
